(19) United States
(12) Patent Application Publication
(10) Pub. No.: US 2009/0018731 A1
(43) Pub. Date: Jan. 15, 2009

(54) PERSONAL COMPUTER CONTROL FOR VEHICLES

(75) Inventors: Travis L. Grenell, Currie, NC (US); Kevin J. Bart, Grand Rapids, MI (US); Charles E. Lippert, Grand Rapids, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: MOBILE OFFICE, INC., Grand Rapids, MI (US)

(21) Appl. No.: 11/776,685

(22) Filed: Jul. 12, 2007

(51) Int. Cl. G06F 19/00; G05D 1/00; G06F 3/01

(52) U.S. Cl. 701/51; 701/1; 701/213; 701/70; 701/93; 701/99

(57) ABSTRACT

A computer control system includes methods and devices for disabling an electronic device, such as a computer, when a mobility status of the vehicle changes. The mobility status may be measured with reference to the vehicle's transmission, parking brake, odometer, speedometer, throttle, engine rpm, or a geographic locating system such as a GPS system. When the mobility status of the vehicle changes to one in which the vehicle is moving, or is more likely to move, the control system disables the electronic device. The control system thus prevents drivers of automobiles and trucks from simultaneously driving while using the electronic device. The system may include one or more override keys and enabling hubs that allow a person to use the device in locations remote from the automobile. The system may also allow the device to be used when it is inside the vehicle but the vehicle's engine has been turned off. The software used by the system includes multiple security features adapted to prevent people from disabling the software such that they would be able to simultaneously drive and use the electronic device.

### BACKGROUND OF THE INVENTION

The present invention relates to personal electronic devices, such as computers, that may be used within a mobile vehicle, such as an automobile or truck.

In a variety of different business situations, people find it convenient to carry a laptop computer, a personal digital assistant (PDA), a cell phone, or other device with them in their car. Sale personnel who travel in their automobile, for example, may find it useful to carry a laptop computer or PDA with them to keep track of sales records, customer information, routing information, and a variety of other types of information that may be useful for carrying out their job. Other people holding jobs that require them to travel to different locations where they perform tasks assisted by computers may also find it beneficial to carry a laptop computer or PDA with them in their vehicle.

The transportation of portable computers, PDAs, and/or cell phones in automobiles, however, can create the temptation for the driver of the car to simultaneously attempt to use the electronic device while driving. Such usage of electronic devices while driving can create a distraction for the driver, and such distractions may cause the driver to become involved in a traffic accident. Employers of workers who drive cars or trucks while transporting portable computers, PDAs, or cell phones may therefore institute strict policies against workers using such devices while driving in order to help prevent accidents and reduce liability issues. Rules against the use of such devices while driving, however, can be broken, and employers may find it difficult to detect the breaking of such rules because they often have limited means for determining whether an employee has been using any one of these devices while driving on the job.

### SUMMARY OF THE INVENTION

Accordingly, the present invention provides a method and device for helping to deter the use of electronic devices while a person is driving a vehicle. The various aspects of the present invention, therefore, help to reduce the likelihood of traffic accidents and help to reduce the potential liability risks to employers of portable-electronics-using drivers. In some aspects, the present invention renders it virtually impossible for a person to use a portable electronic device, such as a computer, while simultaneously driving.

According to one aspect of the present invention, a control system for an electronic device able to be used in a mobile vehicle is provided, wherein the mobile vehicle includes a vehicle sensor adapted to sense a first mobility status and a second mobility status of the mobile vehicle and output a status signal corresponding to the first and second mobility statuses. The control system includes a monitor, a communications channel between the monitor and the electronic device, and software adapted to be run on the electronic device. The monitor is in communication with the vehicle sensor and changes to a first state when the status signal indicates the mobile vehicle has the first mobility status, and the monitor changes to a second state when the status signal indicates the mobile vehicle has the second mobility status. The software determines whether the monitor is in the first state or the second state via the communications channel and disables the electronic device when it determines that the monitor is in the second state.

According to another aspect of the present invention, a method of controlling an electronic device able to be used in a mobile vehicle having a vehicle sensor adapted to sense a first mobility status and a second mobility status of the mobile vehicle is provided. The method includes monitoring a status signal output by the vehicle sensor corresponding to the mobility status of the vehicle and disabling the electronic device when the status signal indicates the mobile vehicle has switched from the first mobility status to the second mobility status.

According to still other aspects of the present invention, the electronic device may be a computer and the monitor may communicate with the computer either via a wired or wireless connection. The vehicle sensor may be any sensor that detects changes in the mobility status of the vehicle, including, but not limited to, sensors that detect changes in the vehicle's parking brake, speedometer, odometer, throttle, transmission, and a geographic position of the vehicle as determined by a Global Positioning System (GPS). When the electronic device is a computer, the disabling of the computer may involve blanking the computer screen while still leaving the computer turned on. The control system may also include one or more override keys that can be attached to the computer and that override the software such that the computer can be used outside of the vehicle. A vehicle-off enabling circuit may be included that allows the electronic device to be used inside the vehicle when the vehicle has been turned off. The monitor may transmit one or more validation messages to the electronic device that carry a signature stream of bits recognizable by the electronic device and that allow the electronic device to validate that an authentic monitor is properly monitoring the vehicle's transmission. The software may be designed to prevent tampering in a variety of different ways, including running multiple programs that monitor each other and automatically re-start each other if one of them is terminated. The software may also track key strokes and instruct the operating system to ignore any keystrokes that would otherwise terminate the operation of the software. The software may also take steps to prevent tampering with any of the registry settings related to the software. A hub may also be provided at a location external to the vehicle that allows a driver to remove the electronic device from the car and plug the device into the hub whereby the hub allows the person to operate the device while plugged into the hub.

The various aspects of the present invention provide a robust system and method for preventing drivers from using electronic devices while simultaneously driving a car or truck. The software and hardware components of the present invention work together to ensure that, as soon as a mobility status of the vehicle switches to a status in which it is more likely that the vehicle is moving, or will move, the electronic device becomes unusable for as long as the vehicle retains the same mobility status. The various aspects of the present invention thereby provide greater assurances of safety to fellow drivers and pedestrians, as well as businesses employing people who drive with electronic devices in their car.

### DESCRIPTION OF THE DRAWINGS

FIG. 1 is a perspective view of a conventional automobile illustrating a portable computer that is being controlled by a control system according to one aspect of the present invention;

FIG. 2 is a schematic diagram of a control system according to a first embodiment of the present invention;

FIG. 3 is a perspective view of a rear panel of a portable computer illustrating a control system monitor and cable plugged into a serial port on the portable computer;

FIG. 4 is a circuit diagram of a monitor according to a first aspect of the invention;

FIG. 5 is a circuit diagram of a vehicle-off enabling circuit and monitor;

FIG. 6 is a circuit diagram of a monitor according to a second aspect of the present invention;

FIG. 7 is a circuit diagram of a user override key;

FIG. 8 is a circuit diagram of a supervisor override key;

FIG. 9 is a circuit diagram of an administrator override key;

FIG. 10 is a perspective view of a hub for enabling multiple portable computers to be used in an environment outside of a mobile vehicle;

FIG. 11 is a plan sectional view of the hub of FIG. 10 illustrating the printed circuit board connections of one row of each of the ports on the hub;

FIG. 12 is a logon screen shot of a software program that may be used to supervise the status of the monitor;

FIG. 13 is a general setup screen shot of the software program of FIG. 12;

FIG. 14 is a screen shot of the software program of FIG. 12 illustrating a screen for changing passwords and usernames;

FIG. 15 is a screen shot of the software program of FIG. 12 illustrating a screen for changing various advanced settings of the software;

FIG. 16 is a schematic diagram of a control system according to a second embodiment of the present invention;

FIG. 17 is a schematic diagram of a control system according to a third embodiment of the present invention; and

FIG. 18 is a schematic diagram of a control system according to a fourth embodiment of the present invention.

### DETAILED DESCRIPTION OF THE INVENTION

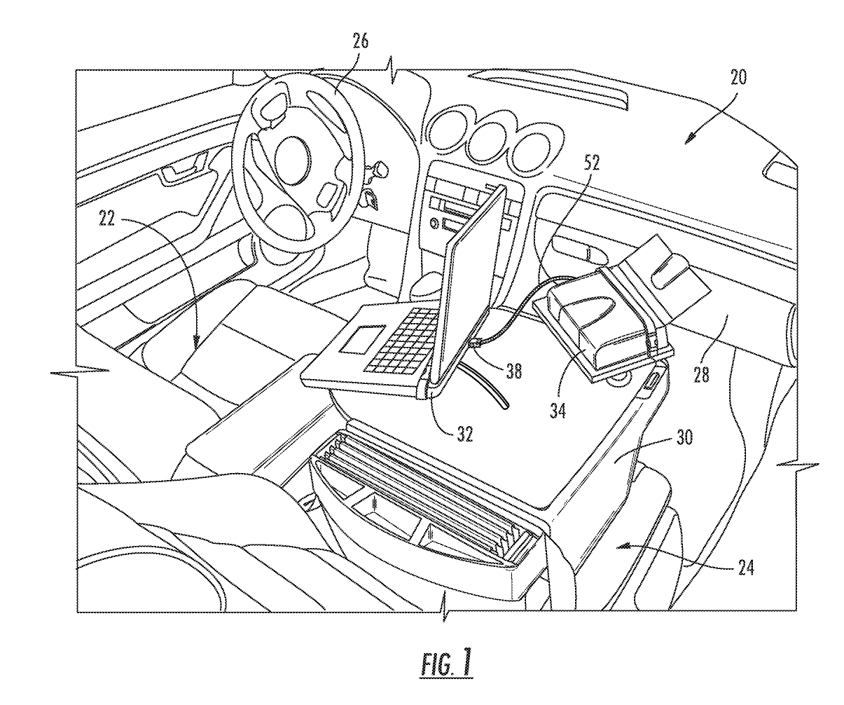

The invention will now be described with reference to the accompanying drawings wherein the reference numerals appearing in the following written description correspond to like-numbered elements in the accompanying drawings. An illustrative example of a conventional automobile interior 20 is depicted in FIG. 1. Automobile interior 20 includes a driver seat 22, a passenger seat 24, a steering wheel 26, and a glove compartment 28. Automobile interior 20 optionally may receive a portable desk and computer support 30 positioned in passenger's seat 24. A portable computer 32 may be positioned on portable desk and computer support 30 and may be connected to a power cable (not shown) that is coupled to the conventional power outlet (not shown) in the interior of the automobile. Portable desk and computer support 30 may also support a computer printer 34 or other computer peripheral equipment, and is of the type disclosed in copending, commonly assigned, U.S. patent application Ser. No. 11/705,206, filed Feb. 12, 2007, the disclosure of which is hereby incorporated by reference herein. Portable deck and computer support 30 forms no part of the present invention but has been depicted in FIG. 1 for purposes of illustrating one way in which a person might use computer 32 inside a vehicle.

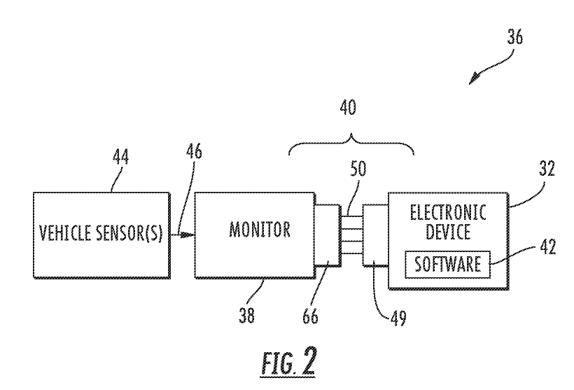

Portable computer 32 is adapted to operate in conjunction with a control system 36 (FIG. 2) according to one aspect of the present invention. While control system 36 may be adapted to control the operation of a variety of different electronic devices, it will be described below with specific reference to controlling a computer 32, which may be portable computer, such as a laptop or notebook style computer, or it may be a computer built into the vehicle itself. Regardless of the type of computer, control system 36 continuously monitors the state of one or more vehicle sensors that sense a mobility status of the vehicle. Depending upon the mobility status that is sensed by the vehicle sensor, control system 36 will either disable or enable computer 32 so that a person will not be able to simultaneously drive and use computer 32.

The particular vehicle sensor that control system 36 monitors may include a variety of different sensors that are either already built into the vehicle by the manufacturer of the vehicle, or that are added thereafter by a third party. As noted, such vehicle sensors 44 detect the mobility status of the vehicle. The mobility status of the vehicle refers to the movement of the vehicle, or the likelihood of movement of the vehicle. The mobility status can be measured by any one or more vehicle sensors. One such vehicle sensor 44 suitable for various aspects of the present invention is the vehicle's parking brake. A sensor that detects whether the vehicle's parking brake is on or off will detect changes in the mobility status of the vehicle. When the parking brake is off, the vehicle is more likely to move than when the parking brake is on. If control system 36 were configured such that vehicle sensor 44 was a parking brake sensor, then control system 36 would disable computer 32 whenever the vehicle's parking brake was turned off and enable computer 32 whenever the parking brake was turned on.

In an alternative embodiment, the mobility status of the vehicle may be defined with reference to the vehicle's transmission. When the vehicle's transmission is in park (for automatic transmissions) or neutral (for either automatic or manual transmissions), the vehicle is less likely to be moved than when the vehicle's transmission is in gear. Thus, when control system 36 is configured such that vehicle sensor 44 detects a state of the vehicle's transmission, control system 36 would disable computer 32 whenever the vehicle's transmission changed to a state in which it was undesirable to allow the driver to still be able to use his or her computer 32 (such as out of park, out of neutral, in gear, or any other desired state of the transmission).

In still other alternative embodiments, control system 36 can be configured to monitor a variety of different vehicle sensors 44 besides the vehicle's parking brake and/or transmission. Vehicle sensor(s) 44 could be in communication with the vehicle's speedometer and/or odometer. In such a case, control system 36 would disable computer 32 whenever the speedometer registered a non-zero reading (or some other low-speed threshold), or whenever the odometer indicated the car was moving. In still other alternatives, vehicle sensor 44 could detect changes in the vehicle's throttle such that whenever the throttle exceeded a predetermined threshold, control system 36 shut down computer 32. Vehicle sensor 44 could also detect the revolutions per minute (rpm) of the vehicle's engine such that control system 36 shut down computer 32 whenever the engine's rpm's exceeded a predetermined threshold.

In yet further alternatives, vehicles sensor(s) 44 could include a global positioning system (GPS) inside the automobile that detected changes in the geographical location of the automobile, or one or more accelerometers, vibration detectors, or other similar sensors that detected the vibrations and accelerations that typically accompany driving. Whenever the GPS system detected the vehicle's geographical position was moving, or whenever the accelerometers, vibration detectors, or other sensors detected sufficient movement and/or acceleration to confidently conclude that the vehicle was moving, control system 36 would either disable or shut down the computer or other electrical device.

Additional sensors 44 not described herein could also be used within the scope of various aspects of the invention. In general, control system 36 can work with any sensor that detects changes in the mobility status of the vehicle wherein the mobility status may be measured by the vehicle's parking brake, transmission, speedometer, odometer, throttle, rpms, vibrations, accelerations, geographic position, etc. However the mobility status is measured, control system 36 is configured to shut down or disable computer 32 in those situations where the mobility status indicates the vehicle is either moving, or more likely to be moving.

Regardless of the particular vehicle sensor 44, computer control system 36 includes a monitor 38, a communications channel 40, and software 42 running on portable computer 32. Monitor 38 is in electrical communication with one or more vehicle sensors 44 that indicate the mobility status of the vehicle, as mentioned above. Monitor 38 may be directly in communication with vehicle sensor 44 itself, or one or more wires that transmit a signal or signals indicative of the sensor's output. For purposes of the following discussion, control system 36 will be described with reference to a vehicle sensor 44 that monitors the mobility status of the vehicle via the vehicle's transmission. Further, monitor 38 will be described further herein as being electrically coupled to one or more wires 60 that transmit one or more signals indicative of the vehicle's transmission state as determined by the vehicle transmission sensor 44. Such wires 60 are standard components of virtually all modern automobiles. Most automobiles with automatic transmissions include at least one car wire 60 that communicates a signal when the vehicle is shifted out of park. For manual transmissions, most automobiles include one or more car wires that transmit signals that indicate what gear the vehicle is in. Regardless of transmission type, these wires are typically accessible somewhere in the cab of the vehicle, such as inside of the glove compartment 28, under a seat, etc. The discussion of control system 36 with reference to the vehicle's transmission and wires 60, of course, will be understood to constitute only one of many possible embodiments of control system 36.

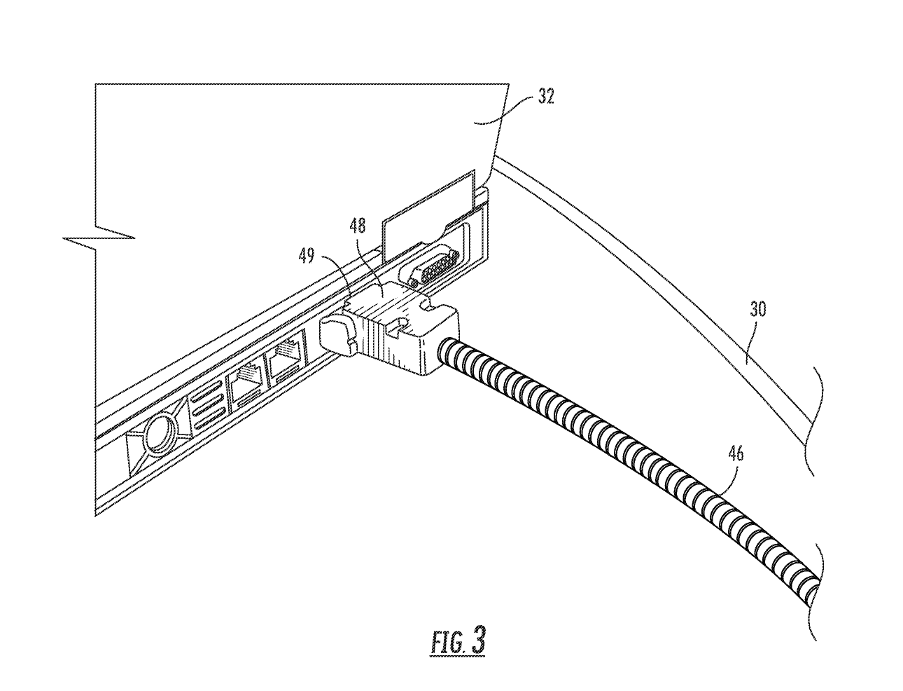

Monitor 38 may be placed in communication with wires 60 by way of one or more conventional inline splices, or by any other suitable means. The signals from car wire 60 may be transmitted to monitor 38 by any known communication means or channel 46, whether wired or wireless. In the embodiment illustrated in FIG. 3, communication channel 46 comprises a conventional cable. Monitor 38 monitors the one or more car wires 60 for signals indicating the vehicle is out of park (for automatic transmissions) or in gear (for manual transmission). When monitor 38 detects that the vehicle has shifted out of park or into gear, it changes from a first state to a second state. The difference between these two states will be explained in more detail below, but in general, software 42 running on computer 32 is able to detect what state monitor 38 is in via communications channel 40. When software 42 detects that monitor 38 is in the second state, software 42 disables computer 32 such that a user may no longer use it. The manner in which software 42 disables computer 32 can be varied, but in one embodiment it includes blanking the screen on computer 32 while leaving the computer 32 turned on. In another embodiment, the keyboard may be rendered inoperative (along with the mouse) while the computer is still on such that computer 32 does not respond to any keystrokes made on the keyboard. Because the user is confronted with a non-responsive computer (that either has a blank screen, an inoperative keyboard, or some other disabled status), he or she will generally be unable to perform any tasks on computer 32 while driving.

FIG. 3 depicts one possible physical manifestation of computer control system 36. As can be seen in FIG. 3, computer control system 36 includes a cable 46 and a connector 48. Connector 48 is physically coupled to an RS-232 interface port 49 on the back of portable computer 32. Cable 46 is in an electrical communication with one or more car wires 60 that monitor the vehicle's mobility status. Monitor 38 is housed within connector 48. The RS-232 connection between portable computer 32 and connector 48 defines communications channel 40. More specifically, communications channel 40 in the embodiment of computer control system 36 shown in FIG. 2 is defined by a connector 66 of monitor 38, interface port 49 of computer 32, and a plurality of pins 50 electrically coupled therebetween. Other types of communications channels 40 may be used within the scope of the present invention, including wireless communications channels, as will be discussed more below.

It should be understood that the physical manifestation of computer control system 36 depicted in FIG. 3 can be varied substantially. For example, instead of using an RS-232 connection between portable computer 32 and connector 38, a variety of different types of connections or interfaces could be used. Such alternative connections include universal serial bus (USB) connectors, parallel ports, non RS-232 serial ports, wireless connections (discussed more fully below) and any other known manner of communicating data to portable computer 32 from an external source. Still further, the physical location of monitor 38 can be varied from that depicted in FIG. 3. Monitor 38 could be located adjacent the car wires 60, rather than in the location adjacent portable computer 32 depicted in FIG. 3. Other physical locations for monitor 38 are also possible. Regardless of the location and physical manifestations of monitor 38 and communications channel 40, software 32 operates in a manner that repetitively checks the status of monitor 38 to determine whether monitor 38 is in the first or second state.

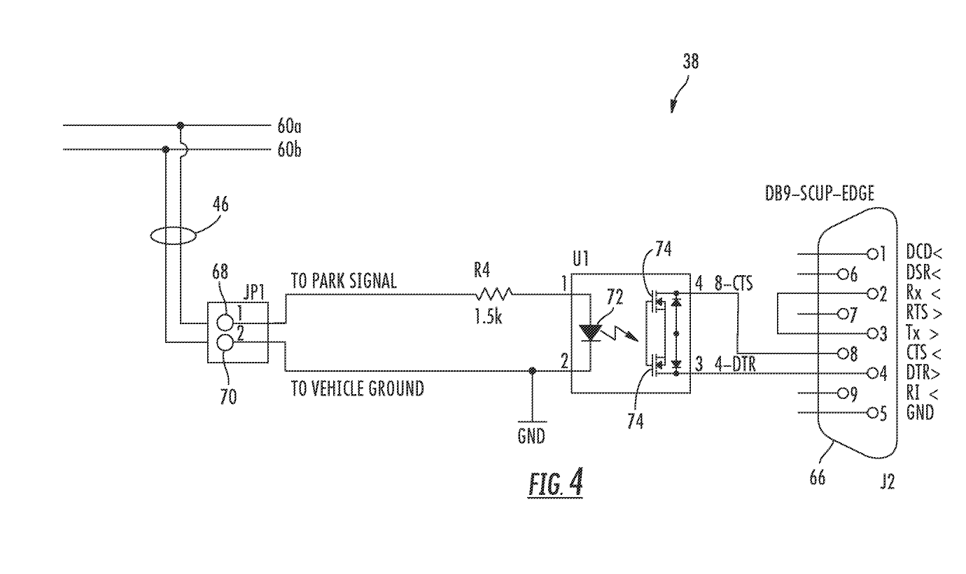

FIG. 4 depicts an electrical schematic of a first embodiment of monitor 38 that may be used in accordance with the present invention. Monitor 38 includes a connector JP1, an optical relay U1, and a conventional DB-9 connector 66. Connector JP1 includes a first terminal 68 and a second terminal 70. First terminal 68 is electrically coupled to a car wire 60a via cable 46. Car wire 60a communicates a status signal generated by a vehicle sensor 44 (not shown) that monitors the state of the vehicle's transmission. Such a vehicle sensor 44 is provided on virtually all automobiles by the vehicle's manufacturer. Car wire 60a transmits a positive voltage when the car's transmission is in park and drops to approximately zero volts when the car is shifted out of park. The voltage on car wire 60a may vary from car to car, and the present invention can be easily adapted to the different voltages that may be used on different car models. In some models of cars, wire 60a transmits a voltage of twelve volts when the vehicle is in park. For purposes of discussion, reference will be made to a high voltage of twelve volts, although it will be understood that this voltage may vary for different cars.

Second terminal 70 of connector JP1 in FIG. 4 is connected by cable 46 to a car wire 60b that is grounded. Thus, when the vehicle's transmission is in park, the twelve volts on car wire 60b will cause a current to flow through resister R4 and a light emitting diode 72 inside of optical relay U1. After passing though diode 72, the current will flow to ground. The light emitted by light emitting diode 72 will activate a pair of transistors 74 inside of optical relay U1. The activation of transistors 74 will electrically couple pins 3 and 4 together on optical relay U1 in essentially a short circuit (transistors 74 may generate a negligible amount of resistance). When light emitting diode is not emitting light, pins 3 and 4 of optical relay U1 will be electrically isolated such that a voltage at pin 3 will not be transmitted to pin 4, or vice versa.

Pins 3 and 4 of optical relay U1 are electrically coupled to pins 4 and 8, respectively, of DB-9 connector 66. DB-9 connector 66 is adapted to mate with interface port 49 on computer 32, which may be a corresponding 9-pin RS-232 serial interface port on the back of portable computer 32. The version of monitor 38 depicted in FIG. 4 also electrically couples together pins 2 and 3 of DB-9 connector 66. As will be discussed below, this coupling is an optional coupling that may or may not be included as part of monitor 38.

If pins 2 and 3 of monitor 38 are electrically coupled together, software 42 can utilize these pins to detect the presence of monitor 38. Software 42 accomplishes this by repetitively transmitting a signal to pin 2 of DB-9 connector 66 and monitoring any response at pin 3 of connector 66. If monitor 38 is physically coupled to portable computer 32, any signal which portable computer 32 transmits to pin 2 of connector 66 will also be transmitted to pin 3 of connector 66. Thus, software 42 will know monitor 38 is present when the signal it transmits to pin 2 of connector 66 is detected at pin 3. If the signal transmitted to pin 2 is not detected at pin 3, then software 42 will know that monitor 38 is not attached to computer 32.

The repetitive transmission of signals to pin 2, and monitoring of pin 3, ensures that monitor 38 is not removed from computer 32 without software 42 being apprised of that fact. If software 42 ever transmits a signal to pin 2 that is not received at pin 3, then software 42 concludes that monitor 38 is no longer connected and therefore disables portable computer 32. The repetitive transmission of signals to pin 2 of connector 66 thus prevents a user from defeating computer control system 36 by simply unplugging monitor 38.

In addition to repetitively checking for the presence of monitor 38, software 42 also repetitively checks the status of monitor 38. As was noted previously, monitor 38 can switch between first and second states. In the embodiment of FIG. 4, the first state is defined by current passing through light emitting diode 72 and pins 3 and 4 of relay U1 being electrically coupled together. The second state is defined by a lack of current through light emitting diode 72 and pins 3 and 4 of relay U1 being electrically isolated. As was noted previously, when current flows though diode 72, optical relay U1 electrically couples together pins 3 and 4 of optical relay U1. This coupling of pins 3 and 4 of optical relay U1 causes a corresponding electrical coupling of pins 4 and 8 of DB-9 connector 66. Thus, when monitor 38 is in the first state, pins 4 and 8 of connector 66 are electrically coupled together, and any signal which software 42 sends to pin 4 of connector 66 will be transmitted to pin 8 of connector 66. Consequently, as long as monitor 38 remains in the first state, pins 4 and 8 of connector 66 will remain electrically coupled together.

When monitor 38 switches to the second state, which happens when the vehicle switches out of park, optical relay U1 ceases to electrically couple together pins 3 and 4 of optical relay U1. This, in turn, decouples pins 4 and 8 of connector 66. Consequently, when monitor 38 switches to the second state, any signal transmitted by portable computer 32 to pin 4 will not be passed onto pin 8. By repetitively transmitting signals to pin 4 of connector 66 and monitoring the response at pin 8, software 42 is able to determine what state monitor 32 is in. When software 42 determines that monitor 38 has switched to the second state, it disables portable computer 32. When software 42 determines that monitor 38 has switched back to the first state, it re-enables computer 32.

It will be understood by one skilled in the art that monitor 38 can be modified to couple together different pins of connector 66. It will also be understood that, as noted previously, it is not necessary for monitor 38 to electrically couple together pins 2 and 3 of connector 66. Software 42 could be configured to communicate with monitor 38 solely over pins 4 and 8 of connector 66. When so configured, software 42 would both determine the presence of monitor 38 and its state by transmitting signals to pin 4 of connector 66 and monitoring the response at pin 8 of connector 66. So long as the signals transmitted to pin 4 were received at pin 8, software 42 would consider monitor 38 to be present and in its first state. As soon as software 42 detected that the repetitive signals transmitted to pin 4 were not being received at pin 8, software 42 would conclude that monitor 38 either had been physically removed from portable computer 32 or it had switched to its second state. In either situation, software 42 would disable portable computer 32.

It will be apparent to one skilled in the art that monitor 38, as illustrated in FIG. 4, only allows a user to use portable computer 32 while a high voltage is detected on car wire 60a. When the car is turned off, car wire 60a will drop to zero volts, and this will cause monitor 38 to switch to the second state and software 42 to disable portable computer 32. Thus, monitor 38 of FIG. 4 will prevent a driver from using portable computer 32 even if the vehicle has been turned off. In some situations, it may be desirable to allow the driver to use portable computer 32 while the vehicle is turned off. Such situations can be accommodated within the scope of the present invention by a vehicle-off enabling circuit 76, discussed below.

FIG. 5 illustrates a vehicle-off enabling circuit 76 coupled to monitor 38. When monitor 38 is coupled to vehicle-off enabling circuit 76, monitor 38 will switch to, and remain in, the first state for as long as the vehicle's engine remains off (Actually, monitor 38 will stay in the first state for as long as the vehicle's key remains in the off position. If the key is turned to partially activate the vehicle's electrical system, but not the engine, monitor 38 will no longer necessarily remain in the first state, but will instead assume a state based on the state of the vehicle's transmission). Vehicle-off enabling circuit 76 will thus enable a driver to use portable computer 32 while the vehicle's key is in the off position.

Vehicle-off enabling circuit 76 includes a connector J1 that is electrically coupled to four car wires 60a-d. Car wires 60a-d are standard wires that are found on virtually all conventional automobiles (though car wire 60a is only found on automatic transmissions). Car wire 60a, which transmits a high voltage when the vehicle is in park and the engine is on (as described above), is electrically coupled to terminal four of connector J1. Car wire 60b, which is coupled to the car's ground, is electrically coupled to terminal 3 of connector J1. A car wire 60c is electrically coupled to terminal 2 of connector J1. Car wire 60c (which may be yellow on some makes of cars) is connected to a vehicle sensor 44 (not shown) that outputs a high voltage signal (such as twelve volts) when the vehicle is in gear. Such a vehicle sensor is a conventional component of virtually all automobiles. Terminal 1 of connector J1 is electrically coupled to a car wire 60d which transmits a constant high voltage signal regardless of the state of the vehicle's transmission or whether the vehicle is turned on or off. Thus, car wire 60d will transmit a high voltage at all times and in all situations (other than those instances when the car battery fails).

Vehicle-off enabling circuit 76 essentially functions as a logical OR gate. That is, circuit 76 determines whether the signal on terminal 4 is high (i.e. the vehicle is in park and the engine is on), or whether the signal on terminal 2 is low (meaning the vehicle is not in gear, which, if terminal 4 is not high, likely means the vehicle is off—the only other option being neutral). If either condition is met, vehicle-off enabling circuit 76 will generate a high voltage (such as twelve volts) at terminal 5. Terminal 5 is electrically coupled to resistor R4 of monitor 38. Monitor 38 depicted in FIG. 5 is the same as, and operates in the same manner as, monitor 38 depicted in FIG. 4, discussed above. More specifically, monitor 38 will remain in the first state as long as a high voltage is fed to resistor R4. Thus vehicle-off enabling circuit 76 will provide a high voltage to resistor R4 either when the vehicle's transmission is in park and the engine is on, or the vehicle's engine is off (or the engine is on but the transmission is in neutral). Monitor 38 will therefore allow computer 32 to be used when the vehicle's transmission is either in park or neutral or the engine is shut off.

The detailed manner in which vehicle-off enabling circuit 76 operates will now be described. So long as the vehicle's transmission is in park and the engine is on, vehicle-off enabling circuit 76 will receive a high voltage at terminal 4. This high voltage will forward bias a diode D1A and cause a current to flow therethrough. The current flowing through diode D1A will be prevented from flowing through a second diode D1B because of the polarity of diode D1B. Thus, the current flowing through D1A will flow to terminal 5 of connector J1, from which it will then flow to resistor R4 of monitor 38. After flowing through R4 of monitor 38, it will activate light emitting diode 72 within optical relay U1. This will cause monitor 38 to assume the first state (described above) in which a driver is able to use portable computer 32. As soon as the vehicle is shifted out of park or the engine is turned off, the high voltage at terminal 4 of connector J1 will drop to zero, thereby sending no current through diode D1A. Whether any current reaches resistor R4 thereafter will depend upon whether any current is flowing through diode D1B.

As was discussed above, terminal 1 of connector J1 remains at a positive twelve volts so long as the car battery does not fail. This twelve volt voltage will selectively forward bias diode D1B depending upon the state of transistor T1. The state of transistor T1 is controlled by the voltage received at terminal 2 of connector J1. As was noted above, terminal 2 will receive a high voltage whenever the vehicle's transmission is in gear. Thus, whenever the vehicle is in gear, the voltage at terminal 2 will pass through resistor R1 and activate transistor T1. The activation of transistor T1 will provide a low resistance path to ground for the current flowing through R2. Thus, the voltage at point P1 when transistor J1 is activated will be very close to zero volts, which is insufficient to forward bias diode D1B. Consequently, no current will flow through diode D1B. When the vehicle's transmission is not in gear, no voltage will be provided to terminal 2 of connector J1. This lack of voltage will shut off transistor T1. When transistor T1 is shut off, the current flowing through resistor R2 will be diverted to diode D1B where it will forward bias diode D1B. The forward biasing of diode D1B will enable the current flowing through resistor R2 to eventually flow to resistor R4 of monitor 38, thereby causing monitor 38 to assume the first state. In summary, then, vehicle-off enabling circuit 76 will provide current to resistor R4 of monitor 38 either when the vehicle is in park (or neutral) and the ignition is turned on, or the vehicle is turned off (regardless of the transmission's state).

When vehicle-off enabling circuit 76 is used on a vehicle having a manual transmission, it can be modified to reflect the fact that the manual transmission vehicle will not have a park signal wire 60a. One such suitable modification would be to replace terminal 4's connection to wire 60a with a connection to another wire that output a high voltage when the vehicle was on and a low voltage when the vehicle was off (or vice versa). Terminal 4 and terminal 2 could then be fed into a suitable logical circuit that produced the desired logic for controlling monitor 38. For example, terminal 4 and terminal 2 could be fed into a logical NAND gate where the output of the NAND gate, or a signal controlled by the output, was supplied to resistor R4 of monitor 38. In that manner, resistor R4 would receive a high voltage signal in all cases except when the vehicle's engine was both turned on and the vehicle was in gear. In all other instances (i.e. the vehicle is off with the transmission in or out of gear, or the vehicle is on with the transmission out of gear), R4 would receive a high voltage signal and monitor 38 would enable computer 32. Other variations are also possible.

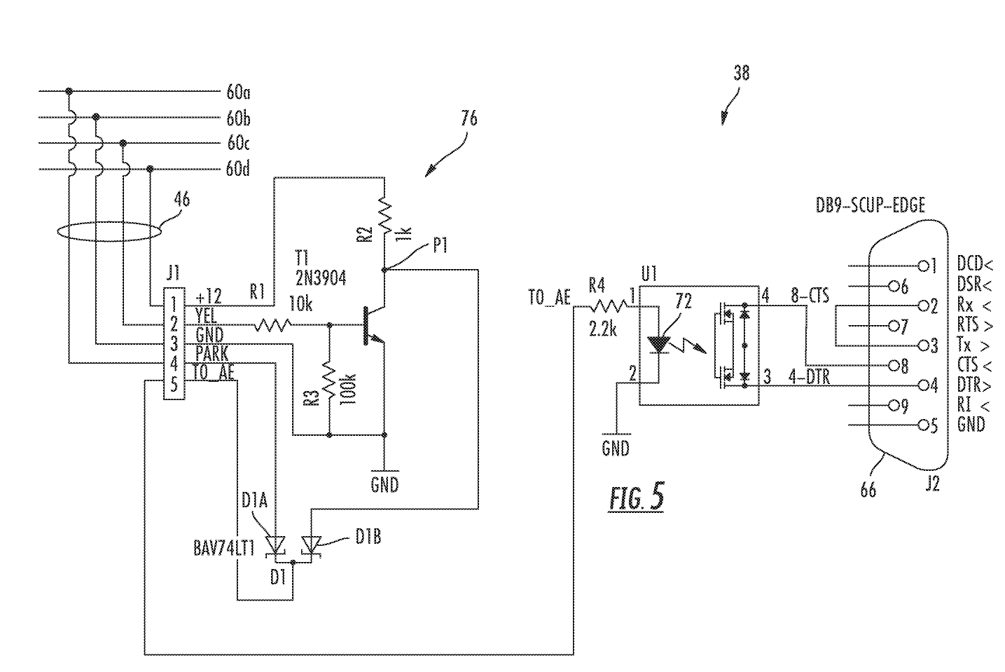

FIG. 6 illustrates a monitor 38′ according to another embodiment of the present invention. Monitor 38′ includes a number of components that are physically spaced apart from each other in FIG. 6. These components include another DB-9 connector 66, a vehicle wire connector JP1, a voltage regulating circuit 80, an optical relay circuit 56 (that includes an optical relay U3), a serial transceiver U2 (which may be a MAX232, or other type of integrated circuit), a microcontroller U4, and a programming connector J2. While all of these components are depicted in FIG. 6 as being physically isolated from each other, they are electrically coupled to each other in a manner specified by the labels applied to the various wires. For example, pin 4 of connector 66 is coupled to a wire labeled DTR. This DTR wire feeds into the wire labeled DTR in the voltage regulating circuit 80. Similarly, pin 3 of connector 66 is connected to a wire having the notation PC_TX. This wire is electrically coupled to the wire on serial transceiver U2 that is also labeled PC_TX. In a similar manner, all wires having a particular label are electrically coupled to all of the other wires having the same label. FIG. 6 has omitted showing the electrical lines coupling the various components together for purposes of not encumbering FIG. 6 with extensively overlapping wires.

Monitor 38′ operates in the same general manner as monitor 38, but includes better security features to inhibit circumvention that might allow a driver to simultaneously drive and use computer 32. Monitor 38′ is electrically coupled to car wire 60a and switches between first and second states depending upon the signal detected at car wire 60a. Software 42 is also adapted to detect which state monitor 38′ is in and disable or enable portable computer 32 accordingly. A vehicle-off enabling circuit 76 could be used with monitor 38′, if desired, to allow use of computer 32 while the vehicle was turned off.

The main difference between monitor 38 and monitor 38′ is the complexity of the communication between monitor 38′ and computer 32. As would be apparent to one skilled in the art, a person could defeat monitor 38 by attaching a DB-9 connector to portable computer 32 that had pins 2 and 3 electrically coupled together as well as pins 4 and 8. Such a DB-9 connector would mimic the first state of monitor 38 such that software 42 would always believe that the vehicle was in park. Such a connector could therefore defeat computer control system 36 and allow a driver to drive his or her vehicle while using portable computer 32. Monitor 38′ includes more advanced features that prevent such circumvention as will be described more below.

Connector JP1 of monitor 38′ is identical to connector JP1 of monitor 38. That is, connector JP1 of monitor 38′ includes a first terminal electrically coupled via cable 46 to car wire 60a and a second terminal electrically coupled via cable 46 to car wire 60b (i.e. ground). As illustrated in FIG. 6, terminal 1 of connector JP1 is coupled to a wire labeled PARK. This PARK wire is electrically connected to resistor R1 of optical relay circuit 56 and feeds into optical relay U3. Thus, when the vehicle's transmission is in park, the high voltage signal on car wire 60a will be transmitted to pin 1 of photo relay U3, thereby activating the light emitting diode 72 within optical relay U3. The activation of this light emitting diode will electrically couple together pins 3 and 4 of optical relay U3. Pin 4 of optical relay U3 is connected to a five volt source labeled VDD. Pin 3 of photo relay U3 is connected to a wire labeled PARK_SIG. This PARK_SIG wire is fed into an input on microcontroller U4. Microcontroller U4 thus knows when the vehicle is in park because it will receive a high voltage signal from the PARK_SIG wire when the vehicle is in park. Further, when the vehicle is shifted out of park, the voltage on the wire will drop to zero and microcontroller U4 will know that the vehicle is no longer in park.

Monitor 38′ receives its electrical power via pins 4 and 7 of connector 66. As can be seen in FIG. 6, pin 4 of connector 66 is electrically coupled to a wire labeled DTR. This DTR wire feeds into a diode D1 in voltage regulating circuit 80. Pin 7 of connector 66 is electrically coupled to a wire labeled RTS. This RTS wire is fed into a second diode D2 in voltage regulating circuit 80. Voltage regulating circuit 80 takes the voltage provided by wires DTR and RTS and converts it into a constant 5 volts that is output on wire VDD. Voltage regulating circuit 80 may utilize a conventional voltage regulator integrated circuit U1, such as a 78L05 voltage regulator. Other voltage regulators may also be used and the overall design of voltage regulating circuit 80 can be varied. The constant five volts provided by voltage regulating circuit 80 at wire VDD is used to power serial transceiver U2 and microcontroller U4. Wire VDD also supplies five volts to pin 4 of optical relay U3 and terminal 1 of programming connector J2.

Software 42 detects the presence of monitor 38′ by signals that microcontroller U4 transmits to pin 2 on connector 66. More specifically, microcontroller U4 repetitively transmits validation messages to portable computer 32 via pin 2 of connector 66. These validation messages are transmitted multiple times a second, although other frequencies may be utilized within the scope of the present invention. The repetitive transmission of these validation messages is monitor 38's manner of communicating that it is in the first state. When monitor 38′ switches to the second state, it stops transmitting validation messages. Software 42 is configured to both analyze the content of these validation messages and monitor the frequency at which it receives these messages. If the software 42 does not detect a validation message after a preset amount of time has passed, then software 42 concludes that one of three things has happened: (1) monitor 38′ has stopped working properly, (2) monitor 38′ has been physically decoupled from portable computer 32, or (3) monitor 38′ has switched to the second state. In all three of these cases, software 42 disables portable computer 32.

As noted, software 42 also analyzes the contents of the validation messages transmitted via pin 2 of connector 66. If software 42 determines from the contents of the validation messages that they were not generated by an authentic monitor 38′, software 42 will also disable portable computer 32. Thus, in overview, software 42 must receive sufficiently frequent validation messages from monitor 38′, as well as validation messages with authentic content in order for a person to be able to use portable computer 32.

The validation messages transmitted by microcontroller U4 to portable computer 32 may be defined in any manner that allows software 42 to recognize them but which would be difficult for someone to illicitly replicate. For purposes of description herein, several possible validation messages will be described. It will be understood, however, that the validation messages described herein are not the only formats that may be used within the various aspects of the present invention.

Microcontroller U4 may be programmed to transmit validation messages containing a pseudo-random sequence of bytes. In one embodiment, microcontroller U4 stores sixteen separate bytes of data that each contain eight bits of data arranged in a different sequence. Microcontroller U4 transmits a validation messages that consists of eight of these bytes selected on a pseudo-random basis. Because software 42 also has stored in memory the sixteen bytes of data which microcontroller U4 can use in constructing a validation message, software 42 can analyze the validation message to determine whether it came from an authentic source.

Software 42 analyzes the validation messages by comparing the eight bytes within the validation message to the sixteen valid bytes it has stored in memory. If software 42 detects that one or more of the eight bytes in the validation message consists of bits arranged in an order that do not match any of the sixteen valid bytes stored in memory, the software 42 concludes that the validation message did not come from an authentic monitor 38′. If all eight of the bytes in the validation message are found somewhere in the set of sixteen valid bytes stored in the memory of portable computer 32, then software 42 concludes that the validation message came from an authentic source. As long as software 42 continues to receive sufficiently frequent validation messages that it deems are from an authentic source, it will not disable portable computer 32 (provided the car remains in park, or is turned off, if vehicle-off enabling circuit 76 is used with monitor 38′).

In order to further enhance the security of monitor 38′, the validation messages may be modified to include a parity bit in each of the bytes. Software 42 would analyze these parity bits to ensure that an authentic validation message was received. The parity bits may be positioned at the end of each of the bytes, or they may be positioned at another location known by software 42. The use of such parity bits would further enhance the security of monitor 38′ because, even if a user were to gain access to the memory of computer 32 or microcontroller U4 and discover the set of sixteen valid bytes, they would still not know the type of parity being used or the position of the parity bits.

Microcontroller U4 could also be modified to store a set of valid bytes larger or smaller than the sixteen discussed herein. Microcontroller U4 could also be modified to transmit validation messages that were longer or shorter than the eight bytes described herein. Microcontroller U4 could further be programmed such that the content of each validation message included a coded indication of the content of some future validation message. The coded indication would, of course, be decipherable by software 42, but not easily understood by someone looking to circumvent computer control system 36.

In yet another embodiment, microcontroller U4 can be programmed such that the eight bytes of data it transmits in a validation messages are never the same eight bytes of data arranged in the same order for any two consecutive validation messages. In this embodiment, software 42 would be further configured to compare each validation message it receives to the previous validation message it received. If the software 42 detected two consecutive validation messages having the same string of bytes, it would conclude that the validation messages were not transmitted from an authentic monitor 38′ and would thus disable portable computer 32. In general, microcontroller U4 can transmit any type of validation message that software 42 would recognize and that would be difficult for a user to understand sufficiently to circumvent.

Microcontroller U4 can be any of a wide variety of conventional microcontrollers or microprocessors, or any other types of electronic circuit or circuits capable of performing the functions described herein. In the embodiment illustrated in FIG. 6, microcontroller U4 is a model PIC16F688 CMOS microcontroller marketed by Microchip Technology, Inc. of Chandler, Ariz. Microcontroller U4 may be programmed by connecting appropriate wires to programming connector J2. The programming necessary to carry out any of the functions of microcontroller U4 described herein would be well within the abilities of a person skilled in the art and would not require undue experimentation.

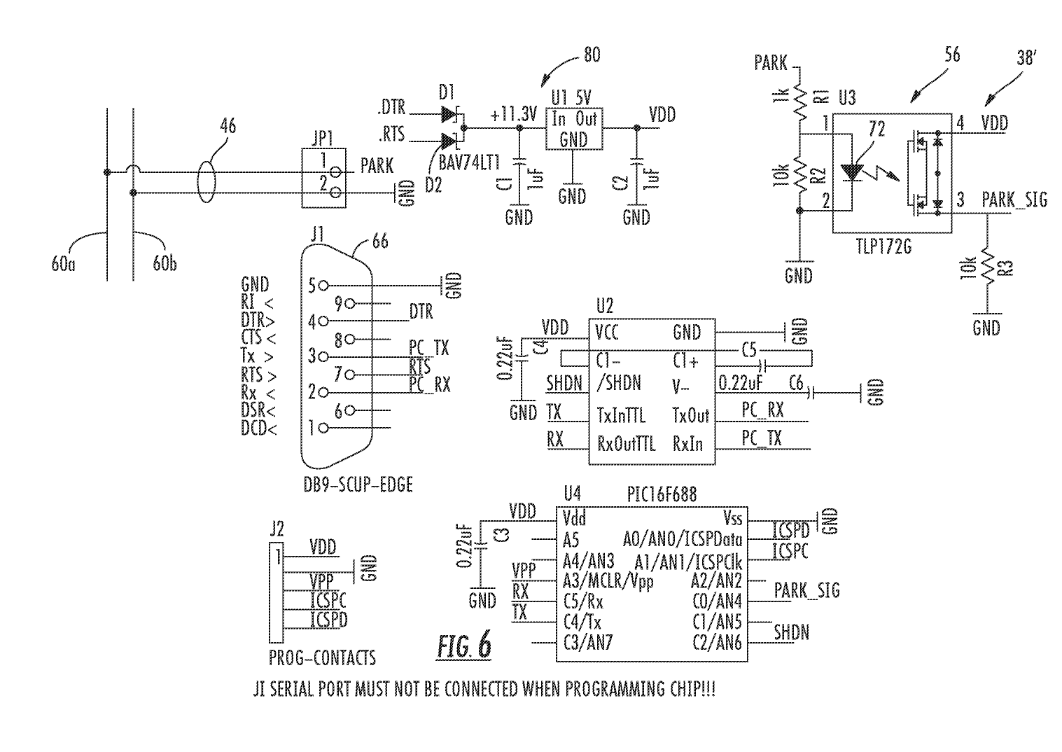

As has been described so far, monitors 38 and 38′ only allow a driver to use computer 32 when the vehicle is in park, or the vehicle is turned off and vehicle-off enabling circuit 76 is used in conjunction with monitor 38 or 38′. In many situations, however, it may be desirable to allow a driver to use his or her computer 32 outside of his or her automobile. In order to allow for such external use, the computer control system 36 of the present invention may optionally include one or more override keys 82 (FIGS. 7-9). The override keys 82 may be physically coupled into a port on computer 32, such as interface port 49, or another port. When so coupled, the override key 82 allows the computer to be freely used, thus enabling the user to use it outside of his or her vehicle.

The provision of override keys 82, however, may allow a driver to circumvent computer control system 36 by simply inserting an override key into computer 32 and then proceeding to drive and use the computer 32 while the override key is plugged in. In order minimize the chances for such situations, the override key may be configured such that a user is only allowed a limited amount of time to use computer 32 while the override key is inserted. After the time limit expires, software 42 disables the computer. While this still theoretically allows the driver to simultaneously drive and use computer 32 for the limited time period, the time limit may be set such that any simultaneous driving and computer usage would be relatively minimal.

In order to further dissuade drivers from simultaneously driving and using computer 32 with an override key inserted, software 42 may desirably be configured to keep a log of the time, date, and duration of every use of an override key. This log could then be monitored by a supervisor or some other third person who could review the times and frequencies of usage of the override keys for any suspicious activity. If any suspicious activity were detected, the employee who used computer 32 could have his or her override key taken away, or be appropriately reprimanded. Still further, the log could keep track of all usages of the computer 32, regardless of whether or not an override key 82 was used or not. By periodically checking when an employee uses computer 32, via the log, it may be possible to determine if he or she has been using computer 32 while driving. Such a determination might be made, for example, in combination with knowledge of the employee's driving and/or work schedule.

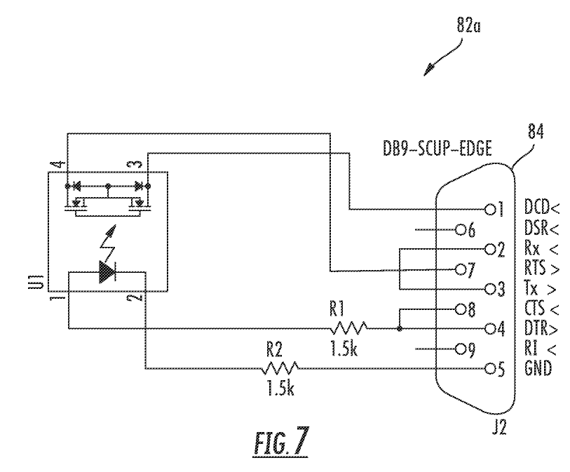

In some situations where it is desirable to provide override keys 82, it may further be desirable to have different types of override keys that grant different privileges to the person using the override key. In that way, different personnel within a company may be provided with different types of override keys depending upon their job functions, their managerial status, or other appropriate factors. FIGS. 7-9 illustrate three different types of override keys 82 that may optionally be used with computer control system 36. FIG. 7 illustrates the circuitry of a user override key 82a. FIG. 8 illustrates the circuitry of a supervisor override key 82b. FIG. 9 illustrates the circuitry of an administrator override key 82c. These three different keys grant the person possessing them different privileges for using portable computer 32, as will be discussed more below. By appropriately distributing such keys to different employees, a company can allow its employees access to their computers when they are not in a vehicle, but still limit the ability of the employees to drive while using their computers.

The physical configuration of override keys 82 may be varied substantially and can take on any suitable form for carrying out one or more of the functions described herein. In one embodiment, override keys 82 are devices that are plugged into the same RS-232 port on portable computer 32 that communications channel 40 is plugged into. In order to use such an override key 82, therefore, a user must first unplug the DB-9 connector 66, if present, before inserting the override key 82 therein. If portable computer 32 is switched on when connector 66 is unplugged, software 42 will disable the computer because it no longer will detect any monitor 38 or 38′. However, once the user inserts one of the override keys 82 into computer 32, the override key will mimic the signals of monitor 38, thereby re-enabling the computer for use.

FIG. 7 depicts the circuit diagram of a user override key 82a that may be distributed to personnel who are classified as general users, rather than as supervisors or administrators, according to one aspect of the present invention. User override key 82a includes a DB-9 connector 84 having nine pins, some of which are connected to an optical relay U1, and others of which are electrically coupled to resistors R1 and R2. DB-9 connector 84, like DB-9 connector 66 discussed previously, is physically configured to be inserted into a mating port on portable computer 32 such as, but not limited to, a nine pin RS-232 serial port. It will, of course, be understood that the construction of any of override keys 82a, b, or c could be modified such that they are inserted into another port on portable computer 32, such as, but not limited to, a USB port, a parallel port, a modem port, a serial port other than the RS-232 serial port, or any other conventional input/output channel that enables the computer to communicate with an external device.

As can be seen in FIG. 7, override key 82a is configured such that pins 2 and 3 of DB-9 connector 84 are short-circuited together. Further, pins 4 and 8 of DB-9 connector 84 are likewise short-circuited together. These short circuits mimic the short circuits that are generated by monitor 38 or 38′ when the vehicle is in park (or the engine is turned off with vehicle-off enabling circuit 76 present). Thus, software 42 will enable portable computer 32 while override key 82a is physically attached to computer 42. As was discussed previously, software 42 normally monitors the state of monitor 38 or 38′ by repetitively monitoring pin 8's response to a high voltage signal transmitted to pin 4 of connector 66. The same is true when connector 84 is attached to portable computer 42. That is, software 42 continues to repetitively transmit a high voltage to pin 4 of connector 84. Because of the short circuit in override key 82a between pins 4 and 8, software 42 will detect the signal it transmits from pin 4 at pin 8. After this detection at pin 8, software 42 will enter a subroutine in which it checks to see it any of override keys 82a-c are attached. If it does not detect any, then it concludes the vehicle is in park.

As can also be seen in FIG. 7, various other pins of DB-9 connector 84 are connected to optical relay U1 and either or both of resistors R1 or R2. These additional pin connections are provided in order for software 42 to automatically detect the presence of override key 82a and distinguish it from the other types of override keys (82b and 82c), as well as from monitors 38 or 38′. The manner in which software 42 distinguishes override key 82a from the other structures will now be described.

Software 42 distinguishes override key 82a from the other override keys and from monitors 38 and 38′ by transmitting a high voltage to pin 7 of connector 84 and then monitoring the response at pin 1 of connector 84. The high voltage transmitted to pin 7 by software 42 is transmitted at a time when the voltage at pin 4 is also high. When the voltage at pin 4 is high, optical relay U1 is activated such that pins 3 and 4 of relay U1 are short circuited together. Consequently, the high voltage transmitted to pin 7 of connector 84 will be passed to pin 1 of connector 84 where software 42 can detect it. Thus, if software 42 transmits a high voltage at pin 7 (while pin 4 is high) and detects the high voltage at pin 1, then it knows that a user override key is attached, rather than another override key or monitors 38 or 38′.

The detection of a voltage at pin 1 distinguishes override key 82a from monitors 38 and 38′ because, as can be seen in FIGS. 4-6, pin 1 in monitors 38 and 38′ is not connected to anything. Thus, when either of these monitors is connected to portable computer 32, a high voltage transmitted by software 42 to pin 7 will not affect pin 1 of connector 66. Software 42 can thereby distinguish user override key 82a from monitor 38 and 38′.

As was noted previously, when software 42 determines that a user override key 82a is detected, it logs the time and date at which the key was inserted and also records in the log the length of time the key was inserted. Further, software 42 limits the amount of time a person can use override key 82a. Thus, software 42 will begin monitoring the passage of time as soon as the override key 82a is first inserted. After the predetermined time has passed, computer control system 36 will disable portable computer 32.

FIG. 8 depicts the circuit diagram for a supervisor override key 82b, which is different from user override key 82a in that, once inserted into computer 32, software 42 does not limit the amount of time a person can freely use computer 32. Supervisor override keys 82b would thus normally be distributed to only people who needed unlimited access to their computer at locations remote from an enabling hub (discussed below), and/or who could be trusted not to abuse the supervisor override key 82b by using it to simultaneously drive and use computer 32.

Supervisor override key 82b works in the same manner as user override key 82a except it includes slightly different wiring that enables software 42 to distinguish it from the other keys 82 and monitors 38 and 38′. Supervisor override key 82b is configured such that when software 42 transmits a high voltage signal to pin 7 while a high voltage is at pin 4, the high voltage signal of pin 7 will be passed through optical relay U1 to both pin 1 and pin 6 rather than to just pin 1 (as with key 82a). Software 42 is thus able to distinguish supervisor override key 82b from user override key 82a by monitoring both pin 1 and pin 6 of connector 84. If the high signal of pin 7 is received on only pin 1 (while pin 4 is high), then software 42 knows that a user override key 82a is attached. Alternatively, if software 42 detects the high voltage signal of pin 7 at both pin 1 and pin 6 of connector 84 (while pin 4 is high), then software 42 knows that a supervisor override key 82b is attached. By distinguishing between override keys 82a and 82b, software 42 can grant the user of portable computer 32 different access to the computer. The different types of access that can be granted can be varied in any desirable manner, but, as noted above, software 42 may be programmed to react to a superior override key 82b by allowing the person with key 82b to freely use computer 32 for as long as the key 82b is inserted (in contrast to key 82a, which only allows use of computer 32 for a limited amount of time).

FIG. 9 depicts an electrical circuit diagram for an administrator override key 82c according to one aspect of the present invention. Administrator override key 82c functions in a similar manner to override keys 82a and 82b with the exception of the manner in which software 42 distinguishes it from the other keys and monitors. Administrator override key 82c short circuits pins 2 and 3 together and couples a diode D1 across pins 4 and 8 of connector 84. When software 42 transmits a high signal to pin 4, this high signal (minus the diode voltage drop) will be detected at pin 8. As long as software 42 continues to detect a high signal at pin 8 in response to a high signal at pin 4, it will continue to enable portable computer 32. Software 42 determines that an administrator key 82c is present by the response it detects at pin 6 when pin 4 of connector 84 is low. Because connector 84 is a conventional RS-232 serial connection in the illustrated embodiment, a logical low signal on pin 4 is actually equal to a negative voltage. Thus, when software 42 directs a logical low signal to pin 4 of connector 84, this logical low signal will forward bias the light emitting diode in optical relay U1. The light from this diode will connect together pins 3 and 4 of optical relay U1. The connection of pins 3 and 4 of optical relay U1 will couple pins 6 and 7 of connector 84 together. Thus, software 42 can detect the presence of an administrator override key 82c by monitoring the signal at pin 6 when pin 4 is low. More specifically, when pin 4 of connector 84 is low, software 42 transmits a high signal to pin 7. If this high signal at pin 7 is detected at pin 6, then an administrator key 82c is attached. If this high signal is not detected at pin 6, then software 42 knows that an administrator override key 82c is not attached. When software 42 detects the presence of an administrator override key 82c, it not only allows the person to freely use computer 32 without a time limit, it also grants greater access to the internal settings of software 42 such that the person can modify the operation of software 42, as will be discussed more below.

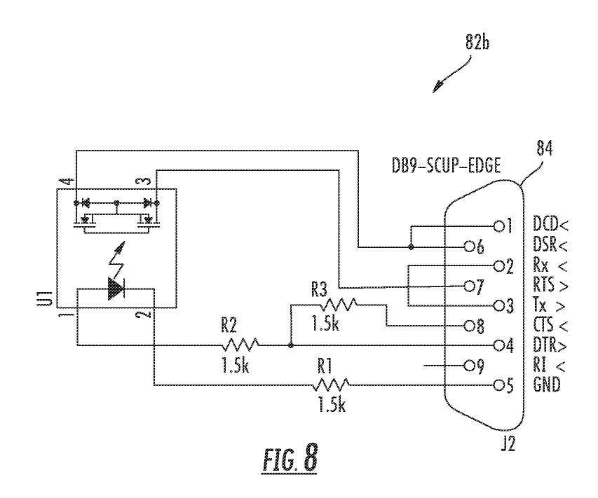

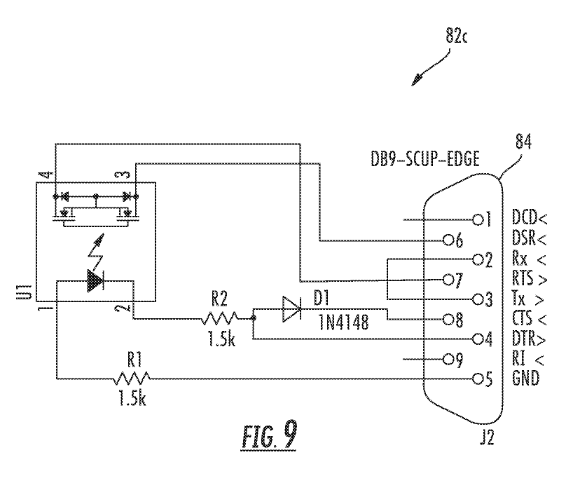

FIGS. 10 and 11 depict an enabling computer hub 86 that may be provided as an optional accessory to computer control system 36. Computer hub 86 includes a plurality of ports 88 which may be coupled to a plurality or computers 32 by way of appropriate cables (such as RS-232 serial cables, or the like). Computer hub 86 may be physically located inside of an office, such as in a conference room or other area where there is space for multiple people to use their portable computers 32. Computer hub 86 is configured to mimic monitor 38 such that when a cable is connected between computer 32 and one of the ports 88 of hub 86, software 42 responds as if it were in communication with a vehicle's transmission that had been shifted into park. In other words, software 42 enables computer 32. Thus, an employee who needs to use and access computer 32 in a physical setting outside of his or her automobile can do so by way of computer hub 86. Indeed, in the embodiment illustrated in FIG. 10, up to twenty-four employees can each plug their computers 32 into hub 86 and freely use their computers (another twelve ports 88 can be positioned on the back side of hub 88). The number of ports 88 on hub 86 can, of course, be varied from that depicted in FIG. 10. Further, it may be desirable to place multiple computer hubs 86 in a variety of different locations within one or more buildings. Employees will thus be able to use their computers outside of their automobiles in multiple controlled locations where there is no danger that usage of their computer could contribute to an automobile accident.

FIG. 11 depicts one embodiment of the internal circuitry of six of the ports 88 (the others are identical) of computer hub 86 that may be used in combination with monitors 38 (but not monitor 38′). That is, the internal circuitry depicted in FIG. 11 will mimic the electrical connections and status signals of monitor 38, but it will not mimic the electrical connections and status signals of monitor 38′. As will be discussed more below, however, it is possible to modify computer hub 86 such that it will mimic the signals of monitor 38′.

As can be seen in FIG. 11, each port 88 includes nine pins. Pins 2 and 3 of each port 88 are short-circuited together. Also, pins 4 and 8 of each port 88 are short-circuited together. By short-circuiting these two pairs of pins, computer hub 86 will continuously mimic the first state of monitor 38. As was noted above, the first state of monitor 38 is the state that enables portable computer 32 to be used. In brief review, software 42 periodically transmits a high signal to pin 4 of the serial port connector, such as connector 66. If monitor 38 is in the first state, this high signal is transmitted to pin 8, which software 42 then detects. As long as software 42 continues to detect high signals at pin 8 in response to high signals at pin 4, it continues to enable portable computer 32. In the computer hub 86 of FIG. 11, any high signals at pin 4 will automatically be transferred to pin 8 because pins 4 and 8 are short-circuited together in all of ports 88. Thus, a portable computer 32 that is coupled to any of the ports 88 in hub 86 will react in the same manner as if it were connected to a monitor 38 that was permanently in the first state (i.e. it can be freely used).

As was noted above, it would be possible to modify the internal circuitry of computer hub 86 such that it could mimic monitor 38′. Such a computer hub would include a microcontroller, or other processing means, that repetitively transmitted validation messages to pin 2 of each of ports 88. The validation messages would be repetitively transmitted sufficiently often and with the proper content such that software 42 would conclude an authentic monitor 38′ was attached.

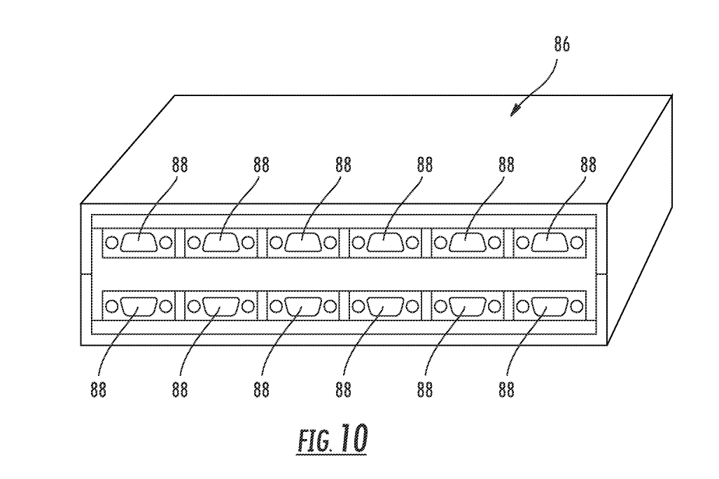

When software 42 is initially installed on a computer 32 by an administrator, one or more computer screens are presented to the administrator enabling him or her to configure software 42 in the desired manner. After the software has been properly configured, the software is set up such that it will automatically start running every time the computer is started. Further, the software will run in the background of the computer such that the user normally never sees any indication the software is running other than, perhaps, an icon for the software 42 in the operating system's system tray. The computer 32 will function as it normally would without software 42 present so long as any one of three conditions are met: (1) the computer is connected to a monitor 38 or 38′ and the vehicle is in park (or the vehicle is off and the vehicle-off enabling circuit 76 is present), (2) the computer is connected to a computer hub 86, or (3) one of override keys 82a-c is inserted into computer 32. In either of the first two situations, no special screen or window will be presented by software 42 to the user. In the last situation, when any override key 82a-c is connected to computer 32, a log-on screen, such as log-on screen 90 (FIG. 12) will be initially presented to the user.

Log-on screen 90 includes a username field 92 and a password field 94. Log-on screen 90 is the same regardless of which override key 82a-c is inserted (although the words “user”, “supervisor”, or “administrator” may selectively appear depending on the type of key 82a-c. Log-on screen 90 preferably takes up the entire size of computer 32's screen such that nothing else is visible on the screen except log-on screen shot 90. However, as will be discussed more below, the size of log-on screen 90 can be adjusted by a person having administrator privileges. In order for a person to log in, they must type a proper username in username field 92 and a proper corresponding password in password field 94. Once a proper username and password are entered in fields 92 and 94, respectively, software 42 will remove log-on screen 90 and allow the person to use computer 32.

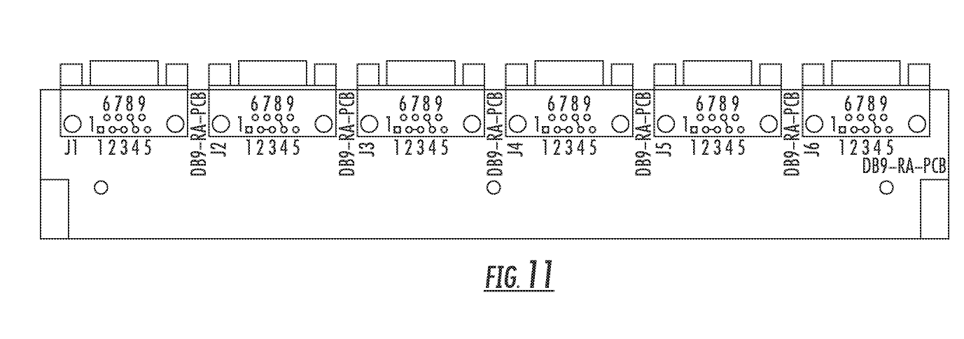

If the user who logged on had inserted a key 82a, they will be allowed to use computer 32 for only a limited time period (such as ten minutes, or any other suitably limited time period). If the user who logged on had inserted a supervisor key 82b, they would be allowed to freely use computer 32 for an unlimited time period. If the user who logged on has inserted an administrator key 82c, not only would they be allowed to freely use computer 32 for an unlimited time, they would be granted access to the control settings of software 42, such as those illustrated in FIGS. 13-15.

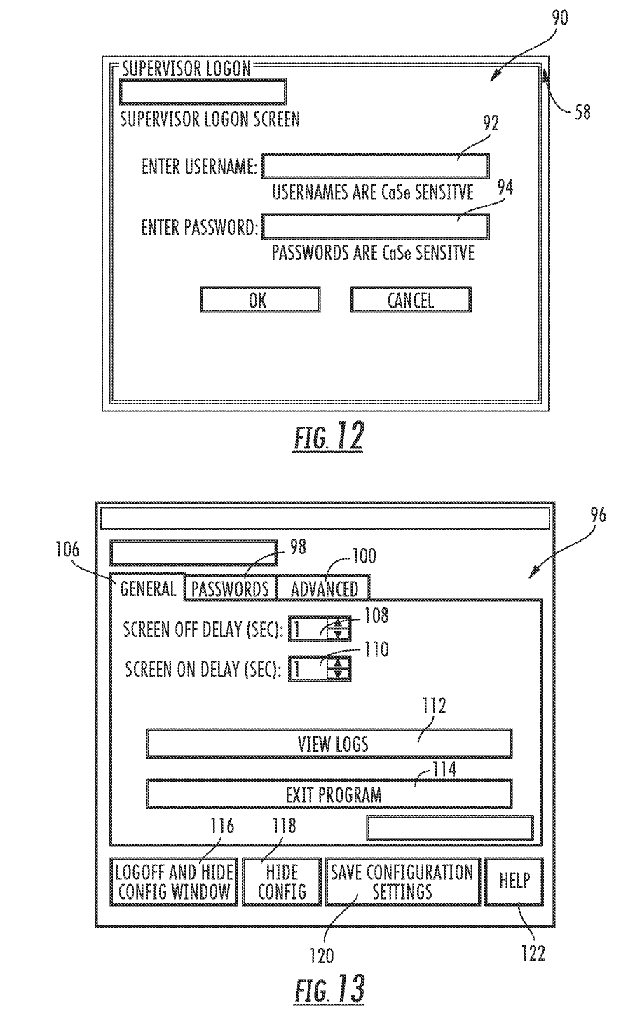

The screen shots of FIGS. 13-15 are only displayed to personnel who are classified as administrators. Stated alternatively, personnel with override keys 82a or b cannot access or see the contents of the screen shots of FIGS. 13-15. FIG. 13 displays a general configuration window 96. General configuration window 96 includes a passwords tab 98 and an advanced tab 100. When a user mouse clicks on the passwords tab 98, software 42 displays passwords configuration window 102 illustrated in FIG. 14. When a user mouse clicks on advanced tab 100 of general configuration window 96, software 42 displays an advanced configuration window 104 such as that illustrated in FIG. 15. General configuration window 96 also includes a general tab 106 that likewise appears in password and advanced configuration windows 102 and 104. When general tab 106 is mouse clicked, general configuration window 96 of FIG. 13 appears. Thus, tabs 98, 100, and 106 can be mouse clicked by the user in order to selectively bring up any of the screens illustrated in FIGS. 13-15.

General configuration window 96 (FIG. 13) includes a Screen Off Delay field 108 and a Screen On Delay field 110. A user who must be an administrator can enter values into either of fields 108 and 110. Whatever value is entered into Screen Off Delay field 108 will set the number of seconds that will pass after monitor 38 (or 38′) switches to the second state before software 42 disables computer 32. In other words, Screen Off Delay field 108 allows a user to set how much time will pass after a vehicle is switched out of park before computer 32 is disabled. Screen On Delay field 110 similarly allows an administrator to dictate how much time must pass before computer 32 will be re-enabled after the vehicle is shifted back into park.

General configuration window 96 further includes a View Log button 112, an Exit Program button 114, a Logoff and Hide Window button 116, a Hide Configuration button 118, a Save Configuration Settings button 120, and a Help button 122. When a user clicks on View Log button 112, a screen (not shown) is brought up by software 42 that displays the log maintained by software 42. As was noted previously, this log contains a variety of different information, including the time, date, and duration of all usages of the computer while the vehicle was in park or while any override key 82a-c was used. Still further, it records any attempted changes to various of the settings of software 42, as will be discussed in more detail below. It may also include, if desired, a record of all the keystrokes made by a user of computer 32, thereby enabling an administrator to review each and every program used by the user in addition to those uses related to software 42.

When a user clicks on the Exit Program button 114, all of the current settings of software 42 are saved and software 42 is turned off. Thus, when the Exit Program button 114 is pressed, software 42 terminates and portable computer 32 can thereafter be freely used until the computer is turned off or re-booted. When a user presses the Log Off and Hide Configuration button 116, the log in information typed in fields 92 and 94 will be cleared, an icon corresponding to software 42 will be minimized to the operating system's system tray and software 42 will monitor the status of monitor 38 and react accordingly. Further, after Log Off and Hide button 116 is pressed, log on screen 90 will reappear and remain there until the user either logs on again, or the administrative override key 82c is physically removed from computer 32. The return of log-on screen 90 serves as a reminder to the administrator to remove key 82c from the computer.

When a user clicks on Hide Configuration button 116, software 42 will be minimized to the system tray and will monitor the status of monitor 38 or 38′. The log in information provided in fields 92 or 94 will not be cleared, and the user may access configuration screen 96 again by double clicking on the icon in the system tray that corresponds to software 42. Such double clicking will cause log on screen 90 to re-appear. If the administrator wishes to log out, he or she can simply remove the administrator override key 82c from computer 32.

When a user presses the Save Configurations button 120, all the settings that may have been changed in any of windows 96, 102 or 104 are saved. Further, those settings are activated so that they will be utilized by software 42. When an administrator presses Help button 122, a help document is brought up by software 42 that includes instructions for using software 42.

As is illustrated in FIG. 14, passwords configuration window 102 includes three password/username changing options 124a-c. By clicking on option 124a, an administrator's username and/or password may be changed. By clicking on option 124b, a supervisor's username and/or password may be changed. By clicking on option 124c, a user's username and/or password may be changed. Any new password is entered into a password field 126 and confirmed in a password confirm field 128. Any new username is entered into a new username field 130. Once any desired changes are made to a password or username, the user may click on a Save Passwords button 134 to save the changes that were previously made. Alternatively, if he or she does not want to save those changes, he or she can click on a Cancel Password changes button 136 and the changes will not be saved.

In order to change any password, a valid administrator's password must first be entered into an administrator's password field 131. Administrator's password field 131 is included to help ensure that unauthorized password changes are not made in the situation where an administrator might happen to forget to physically remove administrator override key 82c from computer 32, or a user were to gain unauthorized possession of an administrator override key 82c. In either situation, the possession of the administrator override key would not allow changes to be made to passwords and/or usernames without the person also knowing the valid administrator password. Thus, no changes to any passwords and/or usernames can be made without first filling in a valid administrator password in field 131.

Advanced configuration window 104 depicted in FIG. 15 presents a variety of additional options for changing the settings of software 42. Advanced configuration window 104 gives the administrator a variety of different options that may be checked or unchecked, including a Disable Registry Editor option 138, a Disable Task Manager option 140, an Activate Software 42 option 142, a Start With Windows option 144, a Require Administrator Key to Display Admin Login Screen option 146, a Login Screen Size option 148, and a Test Operation option 150. Still further, advanced configuration window 104 includes a communications port field 152 and a user key time limit field 154. Also, advanced configuration window 104 includes a Launch Registry Editor button 156, a Launch Task Manager button 158, and an Uninstall button 160. The operation of each of these options, fields, and buttons will now be described below.

Communications port field 152 allows an administrator to select which communications port on portable computer 32 will be used for connecting to monitor 38 or 38′ or any of override keys 82a-c. Thus, if portable computer 32 includes multiple serial ports, parallel ports, or other types, an administrator can configure software 42 to use any one of these ports for communicating with monitors 38 or 38′, or override keys 82a-c.

The user key time limit field 154 enables the administrator to change the amount of time that a user may freely use portable computer 32 while a user override key 82a is inserted. As was discussed above with respect to the user override key 82a, such a key enables a user to freely use portable computer 32 for only a limited time. The amount of this limited is adjustable by way of user key time limit field 154.

The Disable Registry Editor option 138 can be checked or unchecked by an administrator. When checked, software 42 prevents the registry editor of the operating system from being accessed by a user at any time computer 32 is operating. Checking option 138 will thus prevent a user from disabling software 42 by making changes to the registry. The Disable Registry Editor option 138 is therefore normally checked by default when software 42 is installed. This helps to prevent users from circumventing the computer control system 36 by making changes to software 42's registry settings using the operating systems registry editor. When implemented on a Windows operating system, software 42 disables the registry editor by changing a known registry setting built into Windows that, when changed, prevents access to the registry editor.

The Disable Task Manager option 140 can be checked or unchecked by the administrator. When checked, software 42 prevents the task manager window of the operating system (such as Microsoft Windows) from appearing, even if the user presses the control-alt-delete key sequence. By checking the Disable Task Manager option 140, the administrator can thereby prevent a user from trying to shut off software 42 via the task manager window. The Disable Task Manager option 140 is normally unchecked by default when software 42 is installed because a user may need to access the task manager to terminate other programs that have stopped responding. While allowing a user access to the task manager might appear to give a user the ability to shut off software 42 via the task manager, software 42 may desirably include a security feature in which a monitoring program runs simultaneously with software 42 wherein the monitoring program and software 42 automatically re-start one another if either one is shut off. This security feature is described more below and prevents a user from shutting off software 42 via the task manager.

The Activate Software option 142, when checked, causes software 42 to run and operate in the manner described herein. When option 142 is not checked, software 42 does not run and the status of monitor 38 or 38′ is not checked, thereby allowing the computer 32 to be freely used. When the Start With Windows option 144 is checked, software 42 will automatically start running as soon as the computer is booted up. It will, of course, be understood that the present invention can be adapted to work with computers that utilize operating systems other than Microsoft Windows operating systems, such as, but not limited to, UNIX, Linux, OS, and embedded systems having no separate operating system. Thus, the Start With Windows option 144 would be modified to refer to a different operating system or embedded system if computer control system 36 were adapted to a non-Windows operating system or embedded system. The Activate Software option 142 is checked by default.

The Require Administrator Key to Display Login Screen option 146 prevents, when checked, anyone from accessing the log on screen 90 presented to administrators unless they have an administrator override key 82c. Checking option 146 thus helps prevents users from guessing the username and password for an administrator. When installed, software 42 checks this option by default.

The Login Screen Size option 148 dictates the size of log-on screen 90 when it is displayed. When option 148 is checked, log-on screen 90 takes up the entire display of computer 32. When unchecked, log-on screen 90 only takes up a portion of the screen of portable computer 32. When installed, software 42 checks option 148 by default.

The Test Operation option 150, when checked, commences operation of software 42 in a manner that enables its functions to be more easily tested. Specifically, instead of disabling computer 32 when it detects that monitor 38 is in the second state, it simply cause a change in color to the icon in the system tray when monitor 38 or 38′ switches to the second state. By viewing the different colors of the icon for software 42, an administrator can test to see whether software 42 and computer control system 36 are operating properly without having the computer 32 be completely disabled. When software 42 is initially installed, the Test Operation option 150 is unchecked by default. If an administrator checks option 150, the option is automatically unchecked when the computer shuts down.

If an administrator clicks on the Launch Registry Editor button 156, the operating systems registry's editor will be brought up and software 42 will allow the administrator to make changes to the registry. When the Launch Task Manager button 158 is pressed, software 42 will bring up the operating system's Task Manager window and allow the user to freely access and use the Task Manager. When the Uninstall button 160 is pressed, software 42 is uninstalled from portable computer 32. It should be noted that the specific options, fields, buttons, and screens discussed above with respect to FIGS. 12-15 are but one possible manifestation of software 42. Software 42 can be modified in any manner that allows it to monitor the status of an attached device, such as monitor 38 or 38′, and disable computer 32 when the vehicle's transmission in not in park.

In addition to carrying out the functions discussed above with respect to FIGS. 12-15, as well as the other function discussed above, software 42 may also be configured to include a number of security features designed to inhibit tampering by unauthorized personnel (i.e. anyone other than administrator). Some of these features have already been discussed, such as the selective disabling of the operating system's task manager and registry editor. Another feature, not discussed above, include the lack of a program close button in an upper right hand corner 58 of log-on screen 90 (FIG. 12). The lack of this button prevents a user from simply shutting off software 42 by clicking the “X” button that normally appears in the upper right hand corner of most windows in the Windows operating systems.

Another security feature of software 42 is the prevention of more than one instance of the software 42 from running at the same time. In Windows based operating systems, it is typical for the operating system to assign a PID number to each process. Software 42 is programmed to monitor whether multiple instances of itself are running. If multiple instances are running, it shuts off all of those instances except the one with the lowest PID number. This features helps prevent problems that may be caused by multiple instances of the software 42 attempting to access and control the signals passing through communications channel 40.

Another security feature of software 42 that may be provided is the monitoring of the registry settings for software 42. Specifically, software 42 may be configured to monitor all of its registry settings and write them back to their original form if any of them change. Further the content of the registry settings may be encrypted and the registry settings may be given names that are not easily identified or deciphered. This inhibits a user from figuring out which registry settings should be changed in order to circumvent software 42, and prevents a user from altering any setting. Any attempt to alter to the setting corrupts the encryption and it is logged that the setting was tampered with.

Another security feature of software 42 that may be provided is the use of a monitoring program that runs simultaneously with software 42. Software 42 automatically starts this monitoring program shortly after software 42 begins running. Thereafter, software 42 repetitively checks to see if the monitoring program is still running. If it is not, software 42 starts it up again. Similarly, the monitoring program repetitively checks to see if software 42 is running. If it is not, the monitoring program restarts software 42. Thus, software 42 and the monitoring program work in tandem to ensure that neither one of them is shut off by a user. If the user if able to shut one of them down, the other will automatically restart the one that was shut off. The automatic restarting of the program that was shut off will occur fast enough such that it is highly unlikely a user would be able to shut off both software 42 and its monitoring program before one or both of them restarted. Further, any time software 42 or its monitoring program are terminated, this event is stored in the log of software 42.

Another security feature of software 42 that may be included is a feature that relates to the process tree of software 42. In some versions of Microsoft Windows, it is possible to shut off all programs in a process tree simultaneously. Software 42 is configured such that each time it restarts, it starts a new process tree. The same is true for the monitoring program. Thus, if a user succeeds in terminating all of the programs in a particular process tree, this will only affect software 42 or its monitoring program, but not both. Plus, if one of the process trees containing software 42 or the monitoring program is shut off, the other will automatically restart the program that was terminated with a new process tree. The use of new process trees every time software 42 or its monitoring program begins makes it more difficult for a user to shut down both software 42 and its monitoring program. The generation of a new process tree can be accomplished in any conventional manner, such as, but not limited to, by using a freely available software program known as runexe.exe, which is available over the internet at such sites as http://juice.altiris.com, among others.

Another possible security feature that may be included in software 42 is the monitoring of key strokes made by a user of portable computer 32. If this feature is included, software 42 monitors the user's key strokes and ignores the key strokes that might otherwise cause software 42 to terminate. One such set of key strokes that could be used to terminate software 42 is the Alt-F4 combination of key strokes. Software 42 may be configured to instruct the computer's operating system to ignore any key strokes that include the sequence of the Alt key followed by the F4 key.

Another security feature of software 42 that may be included involves preventing software 42 from being included in the operating systems “Add or Remove Programs” window. As is known to users of Windows operating systems, the “Add or Remove Programs” window brings up a list of software that is installed on the computer that may be removed. Software 42 is configured such that it will not be listed in this window. Therefore, a user cannot disable software 42 by accessing the “Add or Remove Programs” window.

Another security feature that may be included with software 42 is the duplication of all of its registry settings in an encrypted file on portable computer 32. The encrypted duplication of software 42's registry settings allows software 42 to automatically restore its original registry settings any time an unauthorized change is made to those registry settings. Also, the default registry settings may be hard-coded so that in the event both the registry settings and the encrypted file are both gone, software 42 reverts to the hard coded defaults.

Another security feature that may be included with software 42 is the use of multiple start-up file locations in the registry. The use of multiple start-up locations makes it difficult for a user to prevent software 42 from running by simply deleting the start up files for software 42. Further, the multiple start-up locations may be stored in locations that are not obvious to the user. For example, software 42 may store one or more start up files in a special registry key that it itself creates and which it assigns a name that is not suggestive of its function. This further inhibits a user from deleting all of the start-up files for software 42. While such multiple start-up locations will cause software 42 to begin running multiple instances of itself, as noted above, software 42 is programmed to terminate any multiple instances of itself, with the exception of the one with the lowest PID number. Thus, software 42 and its monitoring program may be started up multiple times, but only the instance with the lowest PID number will continue. The rest will be terminated.

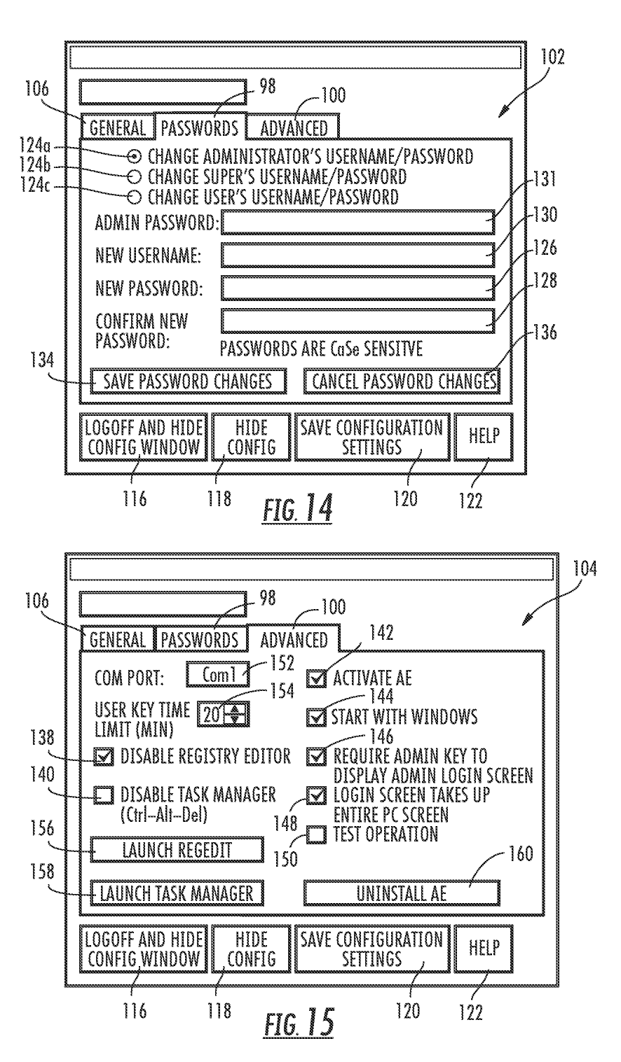

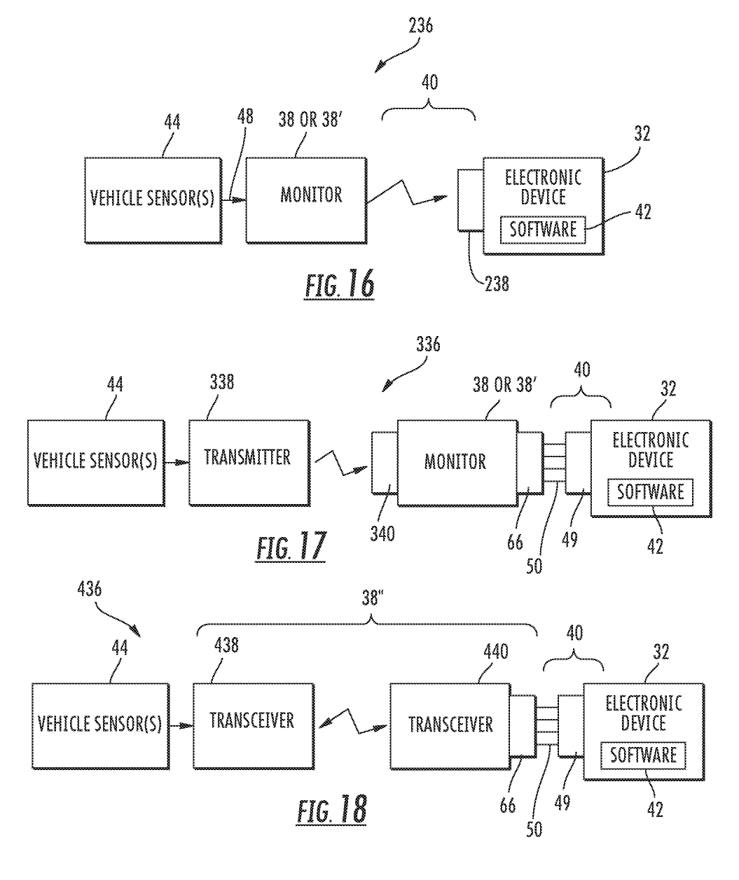

FIGS. 16-17 illustrate various alternative embodiments of a computer control system that may be practiced in accordance with one or more aspects of the present invention. FIG. 16 depicts a computer control system 236 having one or more vehicle sensors 44, a monitor 38 (or 38′), a communications channel 40, and a computer 32. Computer control system 236 is identical to computer control system 36 with the exception of communications channel 40. In computer control system 236, communications channel 40 is a wireless communications channel. Thus, instead of monitor 38 or 38′ plugging directly into computer 32, monitor 38 or 38′ transmits wireless signals to computer 32. These wireless signals may be transmitted to a receiver 238 that is either internal to computer 32 or external to computer 32. The wireless form of transmission between monitor 38 or 38′ and computer 32 may utilize any frequencies the electromagnetic spectrum (e.g. radio frequencies, infrared, etc), and may use any of a variety of conventional wireless formats, such as Bluetooth, WiFi, or any other known or future-developed wireless communications standard.

FIG. 17 illustrates another alternative computer control system 336. Computer control system 336 includes one or more vehicle sensors 44, a transmitter 338, a receiver 340, a monitor 38 or monitor 38′, and a communications channel 40 connected to computer 32. In this embodiment, monitor 38 or 38′ is coupled to computer 32 via a wired communications channel 40 in any manner, such as, but not limited to, the manner described above in computer control system 36. Transmitter 338 wirelessly transmits the signals from vehicle sensors 44 to receiver 340 coupled to monitor 38 or 38′ (utilizing any of the wireless possibilities mentioned in the preceding paragraph). Monitor 38 or 38′ then changes state accordingly, and software 42 reacts by disabling or enabling computer 32.

FIG. 18 illustrates yet another alternative computer control system 436. Computer control system 436 includes one or more vehicle sensors 44, a first transceiver 438, a second transceiver 440, a communication channel 40, and computer 32. In combination, transceivers 438 and 440 comprise a monitor 38″. Monitor 38″ operates in the same manner discussed above with respect to monitors 38 and/or 38′, however, its functions and circuitry are distributed among two different transceivers 438 and 440. The manner in which these functions and circuitry are distributed can be altered in any suitable manner.

For any of the various computer control systems described herein, software 42 may disable computer 32 at the appropriate times by blanking the screen. Such blanking of the screen may be accomplished in any manner known to those of ordinary skill in the art. As one example, when software 42 is installed on a computer 32 running a Windows operating system, software 42 may blank the screen by repetitively triggering the power saving feature of the Windows operating system. While the Windows operating system terminates this power saving feature whenever a user moves the computer mouse or presses a key, software 42 may be programmed to trigger this feature so fast (such as, but not limited to, every millisecond) that the screen will appear to remain blank even if the user touches a key or moves the mouse. Alternatively, software 42 could disable computer 32 by shutting it off, causing it to hibernate or enter the stand-by mode, or still other possibilities.

While the various embodiments of the present invention described above have made reference to a portable computer 32, it will be understood by those skilled in the art that the present invention could be adapted to vehicles that have built-in computers. The present invention would thus prevent a driver from using the built-in computer while simultaneously attempting to drive. The present invention could also be adapted to mobile vehicles besides cars and trucks, such as, but not limited to, boats, airplanes, helicopters, and other mobile vehicles.

While the foregoing description of the security features of software 42 has focused on features that may be provided when using a Windows operating system, it will be understood that the controls systems of the present invention can be easily adapted to operate on computers using different operating systems, including, but not limited to, UNIX, Linux, Mac OS, and other operating systems. Further, when any of the control systems of the present invention are adapted to work on an electronic device other than a computer, such as a cell phone, a PDA, or other device, the present invention can be readily adapted to work with the operating system of the electronic device, or directly with the embedded controller if the device includes an embedded controller with no operating system.

When adapted to work with electronic devices other than computers, any of the control systems of the present invention can be implemented in a wide variety of different manners to operate in conjunction with the electronic device. For example, the monitor 38 or 38′ may be directly plugged into a port on the PDA or cell phone. Alternatively, the monitor 38 or 38′ could be built right into the device itself. As yet another alternatively, the monitor 38 or 38′ could be positioned at a location remote from the device and communicate with the device either wirelessly or by a wired link. If the electronic device is a PDA, the disabling of the PDA can involve any of the same types of disabling that were discussed above with respect to computer 32 (e.g. a blanking of the screen, shutting off the PDA, disabling the keyboard and/or any accompanying stylus, etc). If the electronic device is a cell phone, the disabling can include automatically terminating the call, turning off the cell-phone, generating electromagnetic interference, turning off the sound, or still other techniques.

The construction of monitor 38 or 38′ can also be varied substantially from that described herein. As but one example, monitor 38 or 38′ could be constructed such that a GPS receiver, or other vehicle motion sensor, was built right into monitor 38 or 38′. If the GPS receiver, or other vehicle motion sensor, detected the vehicle was in motion, the monitor would change to the second state.

While the present invention has been described above with respect to multiple embodiments and several variations depicted in the drawings, it will be understood that the present invention can be further modified from the embodiments discussed herein. More specifically, it will be understood that the present invention can be modified in any manner that falls within the spirit and scope of the following claims.

What is claimed is:

1. A control system for an electronic device able to be used in a mobile vehicle having a vehicle sensor adapted to sense a first mobility status and a second mobility status of the mobile vehicle and output a status signal indicative of said first and second mobility statuses, said control system comprising:
a monitor in communication with said vehicle sensor, said monitor adapted to change to a first state when said status signal indicates the mobile vehicle has the first mobility status, and to a second state when said status signal indicates the mobile vehicle has the second mobility status;
a communications channel between said monitor and the electronic device; and
software adapted to be run on the electronic device, said software determining whether said monitor is in said first state or said second state via said communications channel, said software disabling the electronic device when said software determines that said monitor is in the second state.

2. The control system of claim 1 wherein said electronic device is a computer.

3. The control system of claim 2 wherein said vehicle sensor detects changes in at least one of the following: a vehicle parking brake, an odometer on the vehicle, a speedometer on the vehicle, a number of revolutions per minute of an engine on the vehicle, a position of a throttle for the vehicle, and a geographic position of the vehicle as determined by a global positioning system (GPS).

4. The control system of claim 2 wherein said vehicle sensor detects changes in a transmission on said vehicle, said first mobility status is defined by a drive shaft of the vehicle being disengaged from an engine of the vehicle, and said second mobility status is defined by the drive shaft being engaged with the engine.

5. The system of claim 2 wherein said software is further adapted to detect the presence of said monitor and, if said software does not detect the presence of said monitor, said software disables the computer.

6. The system of claim 2 wherein said communications channel is a wireless channel.

7. The system of claim 2 wherein said communications channel is a wired channel.

8. The system of claim 2 wherein said disabling includes at least one of the following: (1) blanking a screen on said computer without switching the computer off, and (2) rendering a keyboard on said computer inoperative such that said computer does not respond to any keystrokes made on said keyboard.

9. The system of claim 2 wherein said software determines what state said monitor is in by sending a message over said communications channel to said monitor and analyzing a response from said monitor sent back to the computer over said communications channel.

10. The system of claim 2 wherein when said monitor is in the first state, said monitor transmits a validation message over said communications channel to the computer, said validation message having a specified characteristic, and said software is adapted to recognize said specified characteristic and disable the computer if the software detects a message not having said specified characteristic.

11. The system of claim 2 wherein when said monitor is in the first state, said monitor repeatedly transmits validation messages to the computer over the communications channel, said software disabling the computer if the computer does not receive one of said validation messages within a threshold time period.

12. The system of claim 11 wherein said validation messages contain a sequence of bits arranged in an order and the order of the bits in any two consecutive ones of the validation messages is different.

13. The system of claim 12 wherein the software monitors the validation messages and, if the software detects two consecutive validation messages having the same order of bits, the software disables the computer.

14. The system of claim 2 wherein when said monitor is in the first state, said monitor repeatedly transmits validation messages to the computer over the communications channel, said validation messages each having a specified characteristic, and said software disables the computer if either one of the following happens:
(i) the computer does not receive one of said validation messages within a threshold time period, or
(ii) the software detects a message not having said specified characteristic.

15. The system of claim 2 further including an override key adapted to be inserted into a port on the computer, said override key configured to mimic said first state of said monitor such that when said override key is inserted into the port on the computer, said software does not disable the computer in response to said status signal.

16. The system of claim 15 wherein said software is adapted to detect when said override key is inserted into the port on the computer and said software generates a password-entry screen on the computer upon detecting the insertion of the override key into the port, said password entry-screen requiring a user to enter a correct password in order to use the computer, said software further adapted to disable the computer if the correct password is not entered.

17. The system of claim 2 further including a first type of override key and a second type of override key, said first type of override key being different than said second type of override key, both of said first and second types of override keys adapted to be inserted into a port on the computer, and both of said first and second types of override keys configured to mimic said first state of said monitor such that when either of said first or second override keys are inserted into the port on the computer, said software does not disable the computer in response to said status signal.

18. The system of claim 17 wherein said software is adapted to recognize whether said first type of override key or said second type of override key is inserted into the port on the computer, said software further adapted to respond in a first manner when said first type of override key is inserted into the port and to respond in a second manner different from said first manner when said second type of override key is inserted into the port.

19. The system of claim 18 wherein said first manner includes disabling the computer after a preset amount of time passes and said second manner includes not disabling the computer after the preset amount of time passes.

20. The system of claim 18 wherein said first manner includes allowing a user to change a setting on the computer, and said second manner includes not allowing the user to change the setting on the computer.

21. The system of claim 4 wherein said monitor includes a microprocessor and an optical relay.

22. The system of claim 2 wherein said software is further adapted to generate a record of each moment in time when said monitor switches into said first state, said software restricting access to said record to only people knowing a correct password.

23. The system of claim 2 wherein said monitor includes a vehicle-off enabling circuit, said vehicle-off enabling circuit adapted to detect when the vehicle engine is not running, and said vehicle-off enabling circuit further adapted to cause said monitor to assume said first state when said vehicle-off enabling circuit detects the vehicle engine is not running.

24. The system of claim 2 wherein said software includes a first program and a second program adapted to run simultaneously with said first program, said first and second programs adapted to monitor each other such that said first program will re-start said second program if said first program detects said second program has stopped, and said second program will re-start said first program if said second program detects said first program has stopped.

25. The system of claim 2 wherein said software monitors each keystroke of the computer and instructs an operating system of the computer to ignore a keystroke, or sequence of keystrokes, that would otherwise cause the operating system to stop running said software.

26. The system of claim 2 wherein said computer uses a Microsoft® Windows® operating system and said software is adapted to generate a new process tree each time said software re-starts.

27. The system of claim 26 wherein the operating system stores registry settings related to said software and said software is adapted to duplicate said registry settings in an encrypted file and restore the registry settings using the encrypted file any time an unauthorized change is made to the registry settings.

28. The system of claim 27 wherein said software includes multiple start-up keys stored at multiple locations, each said start-up key instructing the operating system to start running the software after the computer is turned on, said start-up keys being stored at different locations on the computer.

29. The system of claim 28 wherein said software monitors whether a duplicate instance of said software starts running and shuts down any duplicate instances of said software.

30. The system of claim 29 wherein said mobile vehicle is either an automobile or a truck.

31. The system of claim 2 further including a hub located outside of said mobile vehicle, said hub including a plurality of ports, and said hub configured to mimic said first state of said monitor such that when the computer is electrically coupled to any one of said plurality of ports, said software does not disable the computer.

32. The system of claim 2 wherein said monitor is in communication with said wire via a wireless link.

33. The system of claim 2 wherein said monitor is in communication with said wire via a wired link.

34. A method of controlling an electronic device able to be used in a mobile vehicle having a vehicle sensor adapted to sense a first mobility status and a second mobility status of the mobile vehicle and output a status signal indicative of said first and second mobility statuses, said method comprising:
monitoring said status signal of the vehicle sensor; and
disabling the electronic device when the status signal indicates the mobile vehicle has switched from the first mobility status to the second mobility status.

35. The method of claim 34 wherein said electronic device is a computer.

36. The method of claim 35 wherein said electronic sensor detects changes in at least one of the following: a vehicle parking brake, an odometer on the vehicle, a speedometer on the vehicle, a number of revolutions per minute of an engine on the vehicle, a position of a throttle for the vehicle, and a geographic position of the vehicle as determined by a global positioning system (GPS).

37. The method of claim 35 wherein said vehicle sensor detects changes in a transmission on said vehicle, said first mobility status is defined by a drive shaft of the vehicle being disengaged from an engine of the vehicle, and said second mobility status is defined by the drive shaft being engaged with the engine.

38. The method of claim 35 wherein said disabling of the computer includes at least one of the following: (1) blanking a screen on said computer without switching the computer off, and (2) rendering a keyboard on said computer inoperative such that said computer does not respond to any keystrokes made on said keyboard.

39. The method of claim 35 wherein said monitoring of said status signal includes providing a monitor and wirelessly transmitting said status signal to the computer from said vehicle sensor.

40. The method of claim 35 wherein said monitoring of said status signal includes providing a monitor that switches between a first and second state based on said status signal, said computer determining whether the monitor is in the first or second state by transmitting a message to the monitor and analyzing a response from said monitor.

41. The method of claim 40 further including:
transmitting multiple validation messages to the computer, said validation messages each having a specified characteristic; and
disabling the computer if either one of the following happens:
(i) the computer does not receive one of said validation messages within a threshold time period; or
(ii) the software detects a message not having said specified characteristic.

42. The method of claim 35 further including enabling the computer when an override key is inserted into a port on the computer, regardless of the mobility status of the mobile vehicle.

43. The method of claim 42 further including:
determining if the override key is a first type of override key or a second type of override key;
denying a user of the computer access to a software setting on the computer if the override key is of the first type; and
granting a user of the computer access to the software setting on the computer if the override key is of the second type.

44. The method of claim 35 further including:
monitoring when the mobile vehicle is turned off; and,
enabling the computer if the vehicle is turned off.

45. The method of claim 40 further including:
providing software that allows the computer to communicate with said monitor; and
monitoring each keystroke of the computer and instructing an operating system of the computer to ignore a keystroke, or sequence of keystrokes, that would otherwise cause the operating system to stop running.

46. The method of claim 45 further including:
duplicating a registry setting related to said software in an encrypted file stored in the computer and restoring the registry setting any time a change is made to the registry setting, said step of restoring utilizing said encrypted file.

47. The method of claim 46 further including storing start-up keys for said software in multiple locations on the computer, each said start-up key instructing the operating system of the computer to start running the software after the computer is turned on.
